(19) United States
(12) Patent Application Publication
(10) Pub. No.: US 2023/0026132 A1
(43) Pub. Date: Jan. 26, 2023

(54) SYSTEMS AND METHODS FOR 3D PRINTED MATERIAL SURFACE TREATMENTS

(71) Applicant: Trustees of Tufts College, Medford, MA (US)

(72) Inventors: Andy Cheung, Boston, MA (US); Yoon H. Kang, Natick, MA (US)

(21) Appl. No.: 17/868,857

(22) Filed: Jul. 20, 2022

Related U.S. Application Data
(60) Provisional application No. 63/203,374, filed on Jul. 20, 2021.

(51) Int. Cl. A61C 13/10; A61C 13/00; A61C 13/087

(52) U.S. Cl. CPC A61C 13/102; A61C 13/0019; A61C 13/087

(57) ABSTRACT

A method of creating a reinforced dental prosthesis is provided that can include providing a three-dimensional (3D) printed dental prosthesis, and applying a coating solution to at least a portion of an outer surface of the 3D printed dental prosthesis. The coating solution can include a polymerizable resin and filler particles distributed within the polymerizable resin. The method can include curing the coating solution on the 3D printed dental prosthesis to create the reinforced dental prosthesis.

### CROSS-REFERENCE TO RELATED APPLICATIONS

This application claims priority to U.S. Patent Application No. 63/203,374 filed Jul. 20, 2021, and entitled, “Systems and Methods for 3D Printed Material Surface Treatments,” which is hereby incorporated by reference in its entirety.

### STATEMENT REGARDING FEDERALLY SPONSORED RESEARCH

Not Applicable.

### BACKGROUND

Dental prostheses restore the function (e.g., occlusion), integrity, and morphology of a missing tooth structure, caused by various conditions including, for example, caries, tooth trauma (e.g., chipping of teeth), periodontal disease, etc. While some dental prostheses can last for long periods of time (e.g., years), they can be difficult to manufacture, which can cause undesirable increases in delivery time thereby undesirably impacting patient treatment conformance. Thus, it would be desirable to have improved systems and methods for three-dimensional (“3D”) printed material surface treatments.

### SUMMARY OF THE DISCLOSURE

Some embodiments of the disclosure provide a dental prosthesis. The dental prosthesis can include a body being formed by three-dimensional printing. The body can define an outer surface. The dental prosthesis can include an outer layer coupled to the body and covering at least a portion of the outer surface of the body. The outer layer can include a cured polymerizable resin and filler particles distributed within the cured polymerizable resin.

In some embodiments, a body of a dental prosthesis can be biocompatible. An outer layer of the dental prosthesis can be biocompatible.

In some embodiments, a dental prosthesis can be at least one of a crown, an inlay, an onlay, a bridge, a veneer, or a faux tooth of a partial or full denture.

In some embodiments, a body can be formed from a first cured polymerizable resin. In some embodiments, the first cured polymerizable resin does not include filler particles. A cured polymerizable resin of an outer layer is a second cured polymerizable resin. A first polymerizable resin that forms the first cured polymerizable resin of the body can include at least some of the same components as a second polymerizable resin that forms the second cured polymerizable resin of the outer layer.

In some embodiments, at least some of the same components can include a same type of monomer, or a same type of oligomer.

In some embodiments, a first polymerizable resin can be the same as a second polymerizable resin.

In some embodiments, a cross-sectional thickness of an outer layer can be smaller than a cross-sectional thickness of a body. The cross-sectional thickness of the outer layer can be in a range between about 20 micrometers and about 90 micrometers.

In some embodiments, an outer layer can include a plurality of sublayers. In some embodiments, each of the plurality of sublayers has been cured independently of any of the other sublayers.

In some embodiments, an outer layer can include one or more coupling agents that binds to one or more of the filler particles and the cured polymerizable resin.

In some embodiments, filler particles can each have a width that is within a range of about 0.2 μm to about 0.3 μm. The filler particles can include silica. The coupling agents can include a silane. A polymerizable resin can be used to form the cured polymerizable resin of an outer layer can include a photoinitiator that facilitates curing of the polymerizable resin.

In some embodiments, a body can be formed by three-dimensional printing. An outer layer of a dental prosthesis can have a hardness greater than 30 Vickers Hardness Number (VHN).

In some embodiments, an outer layer of a dental prosthesis can have a hardness greater than 12 Vickers Hardness Number (VHN).

Some embodiments of the disclosure provide a denture. The denture can include a body and a faux tooth coupled to the body that can define an outer surface. The denture can include an outer layer coupled to and covering at least a portion of the outer surface of the faux tooth. The outer layer can include a cured polymerizable resin and filler particles distributed within the cured polymerizable resin.

In some embodiments, a denture can include a plurality of faux teeth that can include a faux tooth. Each of the plurality of faux teeth can include a respective outer surface that can be at least partially covered by a respective outer layer that includes a cured polymerizable resin and filler particles distributed within the cured polymerizable resin.

In some embodiments, an outer layer of a faux tooth can have a hardness greater than 30 Vickers Hardness Number (VHN).

In some embodiments, a faux tooth can be formed from a first cured polymerizable resin. In some embodiments, the first cured polymerizable resin does not include filler particles. A cured polymerizable resin of an outer layer can be a second cured polymerizable resin. A first polymerizable resin that can form the first cured polymerizable resin of the faux tooth can include at least some of the same components as a second polymerizable resin that forms the second cured polymerizable resin of the outer layer.

In some embodiments, an outer layer of a faux tooth can have a hardness greater than 12 Vickers Hardness Number (VHN).

Some embodiments of the disclosure provide a method of creating a reinforced dental prosthesis. The method can include providing a three-dimensional (3D) printed dental prosthesis, and applying a coating solution to at least a portion of an outer surface of the 3D printed dental prosthesis. The coating solution can include a polymerizable resin and filler particles distributed within the polymerizable resin. The method can include curing the coating solution on the 3D printed dental prosthesis to create the reinforced dental prosthesis.

In some embodiments, a coating solution can include a photoinitiator. A method can include directing light at the coating solution to cure the coating solution.

In some embodiments, a 3D printed dental prosthesis has been formed from a first polymerizable resin. A polymerizable resin can be a second polymerizable resin. The first polymerizable resin can be the same as the second polymerizable resin.

In some embodiments, a 3D printed dental prosthesis has been formed from a first polymerizable resin that has a lower fraction of filler particles than a second polymerizable resin.

In some embodiments, a 3D printed dental prosthesis has been formed from a polymerizable resin that does not include filler particles.

In some embodiments, a coating solution can include a coupling agent that can bind to one or more of the filler particles.

In some embodiments, directing light at a coating solution can include directing ultraviolet light at the coating solution.

In some embodiments, an amount of a photoinitiator in a polymerizable resin can be less than five percent by weight, or less than three percent by weight. The photoinitiator can be a phosphine oxide.

In some embodiments, a coating solution can include a coupling agent that can bind to one or more of the filler particles.

In some embodiments, a coupling agent can include a silane. Filler particles can include silica.

In some embodiments, filler particles can each have a width in a range between about 0.2 μm to about 0.3 μm.

In some embodiments, a polymerizable resin can include at least one of a polymerizable monomer, a polymerizable oligomer, or combinations thereof.

In some embodiments, a polymerizable resin can include polymerizable monomers and polymerizable oligomers. An amount of the polymerizable monomers of the polymerizable resin can be greater than 60 percent by weight. An amount of the polymerizable oligomers of the polymerizable resin can be in a range of about 15 percent by weight to about 25 percent by weight.

In some embodiments, a method can include combining filler particles with coupling agents to create a first mixture and combining the first mixture with an amount of alcohol to create a solution.

In some embodiments, a method can include at least one of stirring a solution for a period of time to generate a second mixture or agitating the solution for a period of time.

In some embodiments, a method can include removing at least a portion of an alcohol from a solution to generate a second mixture.

In some embodiments, a method can include stirring or agitating a solution for a period of time until all the alcohol is removed from the solution to generate a second mixture.

In some embodiments, a method can include combining a second mixture with a polymerizable resin to create a coating solution. The polymerizable resin can be a resin that can be a three-dimensional printer compatible resin.

In some embodiments, a dental prosthesis can be at least one of a crown, an inlay, an onlay, a bridge, a veneer, or a faux tooth of a partial or full denture.

In some embodiments, a method can include before applying a coating solution to a dental prosthesis, removing excess uncured polymerizable resin off of a three-dimensional printed dental prosthesis.

In some embodiments, an outer layer of a reinforced dental prosthesis can have a hardness greater than 12 Vickers Hardness Number (VHN).

In some embodiments, an outer layer of a reinforced dental prosthesis can have a hardness greater than 30 Vickers Hardness Number (VHN).

The foregoing and other aspects and advantages of the present disclosure will appear from the following description. In the description, reference is made to the accompanying drawings that form a part hereof, and in which there is shown by way of illustration one or more exemplary versions. These versions do not necessarily represent the full scope of the disclosure.

### BRIEF DESCRIPTION OF THE DRAWINGS

The following drawings are provided to help illustrate various features of non-limiting examples of the disclosure, and are not intended to limit the scope of the disclosure or exclude alternative implementations.

FIG. 1 shows a schematic illustration of a dental prosthesis.

FIG. 2 shows a schematic illustration of a cross-section of a dental crown.

FIG. 3 shows a schematic illustration of a cross-section of the dental crown of FIG. 2 coupled to a crown preparation of a tooth to be restored.

FIG. 4 shows a schematic illustration of a 3D printing system, which can be used to create a dental prosthesis body.

FIG. 5 shows a flowchart of a process for creating a reinforced dental prosthesis.

FIG. 6 shows a flowchart of a process used to create the 3DP resin.

### DETAILED DESCRIPTION OF THE PRESENT DISCLOSURE

Dental prostheses (e.g., crowns, inlays, onlays, bridges, veneers, partial dentures, dentures, etc.) can be used to restore teeth (or lack thereof) from a state of inadequacy to a state that allows for better tooth functionality. For example, after caries excavation, the remaining tooth structure of a tooth may be inadequate for a dental filling, and thus may necessitate a more robust dental prosthesis, such as a crown. In this case, for example, a dental practitioner can create a crown preparation, for engagement with a crown for that tooth to effectively restore the tooth. Typically, the crown preparation of the patient is fitted with a provisional dental prosthesis (e.g., a provisional crown) to regain some tooth functionality while the actual crown is being formed. This wait period can be quite lengthy, as crowns and other dental prostheses are usually manufactured at a remote lab, which requires time for manufacturing the crown, but also for shipping the crown to the dental office. After the crown has shipped, the patient must be brought in again to deliver the actual crown. In some cases, if the specifications of the actual crown are not accurate (or other changes to the crown need to be made), these steps must be undesirably repeated yet again, with the manufacturing and shipping of a new crown. Each of these inefficiencies can not only prolong patient treatment time, but can lead to difficulties with patient treatment conformance (e.g., some patients are less likely to come into the dental office and continue with a treatment plan with additional visits—especially those that are not anticipated).

Some approaches have aimed to eliminate the provisional dental prosthesis step entirely by, for example, creating the dental prosthesis at the dental office. For example, some dental practitioners utilize computer numerical control (“CNC”) milling machines that can create a patient specific dental prosthesis (e.g., a crown) out of a piece of material (e.g., a block). While this can speed up the dental prosthesis delivery process and may even prevent the need for some provisional dental prostheses, the milling approach can have downsides. For example, the geometry of some dental prostheses cannot be adequately milled (e.g., requiring undesirable dental prosthesis shape compromises, in other words, the milled crown cannot be made to an ideal geometry), the milling machines can be prone to fracturing dental prostheses (e.g., increasing the delay time for creating an accurate dental prosthesis), and the milling machines require a high capital cost.

Some other approaches have attempted to avoid the issues of milled crowns, while retaining the manufacturing benefits of milled crowns, by utilizing 3D printed approaches for dental prostheses. For example, a scan of the treatment area (e.g., using an intraoral dental scanner) can be used to generate a 3D volume of the dental prosthesis, which can be utilized to create the physical dental prosthesis according to the 3D volume. This process then allows for more idealistic dental prosthesis geometries as compared to milling dental prostheses (e.g., because additive manufacturing such as with 3D printers can accommodate more complex tooth geometries). While 3D printing can offer ease of use and fairly quick physical creation times, current 3D printing approaches for dental prostheses provide inadequate physical dental prostheses. For example, current 3D printing materials (e.g., filaments, polymerizable resins, etc.), when created into dental prostheses, do not provide a long longevity at least because these materials do not offer the appropriate material properties for proper dental prosthesis functionality (e.g., surface hardness, resistance to surface abrasion, etc.). In fact, 3D printing is currently not even offered for dental prostheses because these dental prostheses would not withstand the forces imposed on them during normal teeth processes (e.g., chewing).

Some embodiments of the disclosure provide advantages to these issues (and others) by providing improved systems and methods for 3D printed material surface treatments. For example, some embodiments of the disclosure provide a method of reinforcing a 3D printed dental prosthesis that can include applying a coating solution to an exterior surface of the 3D printed dental prosthesis and subsequently curing the coating solution to structurally reinforce the 3D printed dental prosthesis so that the material properties (e.g., toughness, hardness, etc.) correspond more closely to a typically structured dental prosthesis (e.g., from a lab). In some embodiments, the coating solution, which forms an outer cured layer can include a polymerizable resin, and filler particles distributed within the polymerizable resin. The filler particles (e.g., silica particles, including fumed silica particles) can structurally reinforce the cured layer to at least in part provide the improved structural characteristics. In addition, the coating solution can include a coupling agent (e.g., silane) that binds to one or more filler particles (e.g., at one end of the coupling agent), and that binds to the polymerizable resin and the cured polymerizable resin (e.g., at an opposing end of the coupling agent). In this way, the coupling agent can also facilitate the improved material properties of the reinforced dental prosthesis (as opposed to the non-reinforced dental prosthesis created just from the 3D printed resin).

In some embodiments, the 3D printed dental prosthesis can be formed from a polymerizable resin (e.g., that is cured during the 3D printing process) that has one or more components (e.g., a type of monomer, a type of oligomer, a type of photoinitiator, a percent by weight of a monomer, an oligomer, or a photoinitiator, etc.) that are the same as one or more components of the polymerizable resin of the coating solution. For example, in some configurations, the type of polymerizable resin that the 3D printed dental prosthesis was formed from can be the same as the type of polymerizable resin of the coating solution. In this way, the coating layer, when cured to the 3D printed dental prosthesis, can better bond to the 3D printed dental prosthesis because the material properties between each polymerizable resin is substantially the same. In other words, a layer of polymerizable resin that is laid on top of a cured polymerizable resin of substantially the same (or exactly the same) material properties (e.g., as is during a 3D printing process) can bond well to each other (e.g., at least because this can be similar to the actual creation of the 3D printed dental prosthesis by curing one extruded layer on top of another, and so on). Thus, correspondingly, if the coating solution has a polymerizable resin that has similar components (and similar material properties) as the polymerizable resin that was cured to form the 3D printed dental prosthesis, then the coating solution can bond well to the 3D printed dental prosthesis.

Reinforcing 3D printed dental prostheses according to the embodiments described herein can have advantages. First, 3D printers generally can create geometries that are superior to other manufacturing methods. In other words, 3D printers can create dental prostheses that have more idealistic geometries (e.g., anatomical tooth geometries), as opposed to other manufacturing methods. Second, structurally reinforcing the outer surface of the 3D printed dental prosthesis (e.g., using the coating solution) considerably increases the material properties, which provides a more ideal dental prosthesis that lasts longer than just a 3D printed dental prosthesis without reinforcement. Advantageously, the filler particles (and other components) of the coating solution can be utilized to structurally reinforce the dental prosthesis, but are generally not available for use in 3D printers. For example, filler particles distributed within a polymerizable resin extruded by a 3D printer would not be able to be properly extruded (e.g., the particles could clog the extruder or other tubing of the 3D printer, the particles could damage the cross-section of the extruder by scraping the surface, the resin may not be able to be extruded to create the desired geometry, etc.).

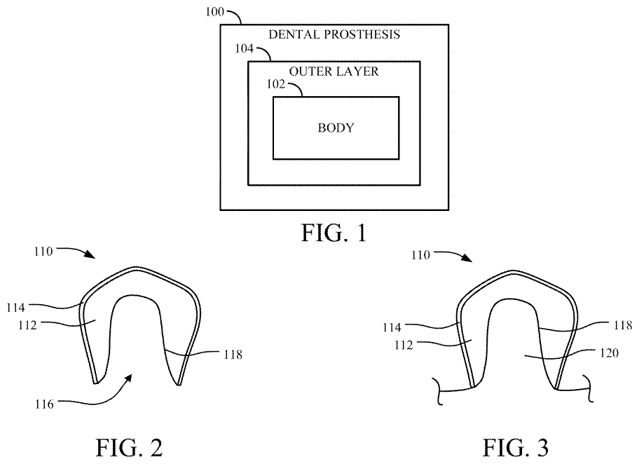

FIG. 1 shows a schematic illustration of a dental prosthesis 100. The dental prosthesis 100 can include a body 102, and an outer layer 104 coupled to the body 102. The body 102 can have an interior surface, and an outer surface opposite the interior surface. In some embodiments, the outer layer 104 can span at least a portion of the outer surface of the body 102. For example, in some specific cases, the outer layer 104 can span the entire outer surface of the body 102. In some configurations, a thickness (e.g., a cross-sectional thickness) of the outer layer 104 can be smaller than a thickness (e.g., a cross-sectional thickness) of the body 102. For example, the body 102 can have a cross-sectional thickness in a range between about 0.5 mm to about 0.5 mm, while the outer layer 104 can have a cross-sectional thickness in a range between about 20 micrometers and about 90 micrometers. In some cases, a mesiodistal dimension of the body 112 can be in a range between about 1 mm to about 12 mm. In some embodiments, a buccolingual dimension of the body 112 can be in a range between about 1 mm to about 8 mm.

The body 102 can be formed from a polymerizable resin (e.g., that has been cured), which is compatible with a 3D printer. Thus, the body 102 can be formed from a 3D printer (e.g., that extrudes, and subsequently cures the polymerizable resin in layers to form the body 102). Accordingly, when the body 102 is formed from a first polymerizable resin, the first polymerizable resin can have a lower amount, a lower fraction (e.g., percent by weight, percent by volume, etc.), etc., of filler particles as compared to the filler particles of a second polymerizable resin used to form the outer layer 104. In addition, the filler particles of the first polymerizable resin of the body 102 can each have a smaller width than each of the filler particles of the second polymerizable resin used to form the outer layer 104. In some embodiments, the first polymerizable resin of the body 102 can be free of filler particles. In other words, the body 102 that is formed from a polymerizable resin does not include filler particles distributed within the polymerizable resin. In this way, when the body 102 is formed using a 3D printer and the polymerizable resin (e.g., by extruding layers of the polymerizable resin), the polymerizable resin can be adequately extruded (e.g., because the polymerizable resin includes filler particles that are relatively small, or the polymerizable resin is free of relatively large filler particles that could undesirably clog the extruder of the 3D printer).

In some embodiments, the polymerizable resin can include one or more polymerizable monomers, one or more polymerizable oligomers, etc. In some cases, the one or more polymerizable monomers can include mono-, di- or multi-methacrylates and acrylates such as 2,2-bis[4-(2-hydroxy-3-methacryloyloxypropoxy)phenyl]propane (“Bis-GMA”), 1,6-bis(2-methacryloxyethoxycarbonylamino)-2,4,4-trimethylhexane (UDMA), 2,2-bis [4-(methacryloyloxy-ethoxy)phenyl]propane (or ethoxylated bisphenol A-dimethacrylate) (“EBPADMA”), isopropyl methacrylate; triethyleneglycol dimethacrylate (“TEGDMA”), diethyleneglycol dimethacrylate; tetraethyleneglycol dimethacrylate; 3-(acryloyloxy)-2-hydroxypropyl methacrylate, 1,3-propanediol dimethacrylate; 1,6-hexanediol dimethacrylate (“HDDMA”), pentaerythritol triacrylate; pentaerythritol tetraacrylate; pentaerythritol tetramethacrylate, (hydroxyethyl)methacrylate (“HEMA”), and combinations thereof. In some cases, the one or more oligomers can include multiple linked monomers of the monomers listed above. For example, the one or more oligomers can include methacrylic oligomers.

In some embodiments, the one or more monomers, and the one or more oligomers can be olefins, halogenated olefins, cyclic alkenes, alkenes, alkynes, or combinations thereof. For example, the one or more monomers, or the one or more oligomers can be 1,6-hexanediol diacrylate (“HDDA”), pentaerythritol triacrylate, trimethylolpropane triacrylate (“TMPTA”), isobornyl acrylate (“IBOA”), tripropyleneglycol diacrylate (“TPGDA”), (hydroxyethyl)methacrylate (“HEMA”), or combinations thereof.

In some embodiments, the body 102 can be a dental prosthesis that can be specific to a particular patient, and in particular, can correspond to one or more teeth (or one or more gaps between teeth) to be restored for the patient. In some cases, the dental prosthesis can be a fixed dental prosthesis (e.g., a crown, a bridge, etc.) or a removable dental prosthesis (e.g., a partial denture, a full denture, etc.). Thus, the body 102 can be a crown, an inlay, an onlay, a bridge, a veneer, a faux tooth (e.g., for testing of teeth including orthodontic bracket bonding testing, training of dental practitioners, for use in a partial or full denture, etc.). In some configurations, as described below, a computing device can generate a 3D volume of a dental prosthesis for a patient, and the 3D printer can receive and print the dental prosthesis from the 3D volume of the dental prosthesis. In some configurations, including when the dental prosthesis 100 is a partial (or full) denture, the dental prosthesis can include multiple bodies 102, each with respective outer layers 104. In this case, for example, each body 102 (and the respective outer layer 104) can be a faux tooth, each of which can be placed and coupled to the denture base (e.g., to create the denture). In some embodiments, the body 102 can include a recess, bore, etc., that is (partially or completely) directed into the body 102. For example, when the body 102 is a crown, the body 102 can include a recess that interfaces with a crown preparation to secure the crown to the crown preparation.

In some embodiments, the outer layer 104 can be formed form a cured coating solution. The coating solution can include a polymerizable resin, filler particles, coupling agents, initiators (e.g., to initiate a polymerization reaction with the polymerizable resin, which can be a photoinitiator, a temperature based initiator, etc.). In some embodiments, the polymerizable resin can be implemented in a similar manner as the polymerizable resin of the body 102. For example, the polymerizable resin used to form the outer layer 104 can include one or more polymerizable monomers, one or more polymerizable oligomers, etc. In some cases, and advantageously, the polymerizable resin used to from the outer layer 104 can have one or more similar components as the polymerizable resin used to create the body 102. For example, the polymerizable resin used to form the outer layer 104 can have the same type of monomer, the same type of oligomer, the same type of photoinitiator (or other initiator, including a temperature based initiator), the same percent by weight of a monomer (e.g., the same monomer), the same percent by weight of an oligomer (e.g., the same oligomer), the same percent by weight of a photoinitiator, etc., as the polymerizable resin used to form the body 102. In this way, the closer the formulation is between the polymerizable resins used to form the body 102 and the outer layer 104, the better the bond strength is at the interface in which the outer layer 104 and the body 102 are secured to each other.

In some embodiments, the filler particles can be distributed within the polymerizable resin of the coating solution (e.g., by mixing the filler particles with the polymerizable resin) and can structurally reinforce the polymerizable resin, which can lead to a stronger and harder cured polymerizable resin (e.g., the outer layer 104). The filler particles can have various sizes. For example, the filler particles can each have a width in a range between about 50 μm and about 0.001 μm, in a range between about 10 μm to about 0.1 μm, in a range between about 1 μm to 0.1 μm, in a range between about 0.2 μm to about 0.3 μm, etc. In some cases, the filler particles can each have a width that is less than 50 μm, a width that is less than 1 μm, a width that is less than 0.3 μm, a width that is less than 0.2 μm, a width that is less than 0.1 μm, a width that is less than 0.01 μm, etc. In some cases, the filler particles can be inert (e.g., chemically inactive). For example, the filler particles can be inert with respect to the chemical interaction directly between the filler particles and the polymerizable resin. In other words, when the filler particles are mixed together with the polymerizable resin, the filler particles do not chemically bond directly with the polymerizable resin (e.g., when the filler particles are inert).

In some embodiments, the outer layer 104 can have various optical properties, such as, for example, to match the color of the outer layer 104 with that of one or more other teeth in the patient's mouth, to match the translucency of the outer layer 104 with that of one or more other teeth in the patient's mouth. For example, the outer layer 104 can have various shades, chroma, etc., that can include one or more hues, which can include yellow, red, grey, etc., selected by a practitioner (e.g., a dentist) to match with one or more teeth of the patient. In some configurations, to yield the desired hue of the outer layer 104, the outer layer 104 can include one or more different pigments (e.g., dental pigments). For example, the outer layer 104 (and the coating solution that forms the outer layer 104) can include one or more different pigment particles each of which can have a primary hue. In some cases, each pigment particle can be metallic (e.g., aluminum oxide, manganese oxide, iron oxide, cobalt oxide, copper, etc.), non-metallic, etc. Regardless of the configuration, the outer layer 104 can have a shade (or a hue) that matches with the shade (or the hue) of one or more teeth within the patient's mouth (e.g., in which the patient's mouth includes a tooth structure that is configured to receive the dental prosthesis).

In some embodiments, the outer layer 104 can have various translucency values, which can depend on the total thickness of the outer layer 104, the number of sublayers of the outer layer 104, etc., with larger thicknesses of the outer layer 104 and larger numbers of sublayers yielding a less translucent outer layer 104 (and vice versa). In addition, the amount of filler particles within the polymerizable resin that forms the outer layer 104 including the fraction of the filler particles can dictate the desired translucency of the outer layer 104 (e.g., to match the translucency of a tooth within the patient's mouth). For example, higher amounts, fractions, etc., of filler particles can block more of the light through the outer layer 104 leading to a less translucent outer layer 104 (and vice versa). As another example, the size of the filler particles can dictate the desired translucency of the outer layer 104, with larger sized filler particles (e.g., particles that are wider) blocking more of the light through the outer layer 104 also leading to a less translucent outer layer 104 (and vice versa). Regardless of the configuration, the outer layer 104 can have a translucency that matches with the translucency of one or more teeth within the patient's mouth (e.g., in which the patient's mouth includes a tooth structure that is configured to receive the dental prosthesis).

The filler particles can be formed of various materials. For example, each filler particle can be formed from silica, fumed silica, strontium borosilicate, strontium fluoroalumino borosilicate glass, strontium alumino sodium fluoro phosphor-silicate glass, barium borosilicate, barium fluoroalumino borosilicate glass, barium aluminum-borosilicate glass, barium alumino borosilicate, calcium alumino sodium fluoro silicate, lanthanum silicate, lanthanum aluminosilicate, calcium alumino sodium fluoro phosphor silicate, silicon nitrides, titanium dioxide, fumed silica, colloidal silica, quartz, kaolin ceramics, calcium hydroxy apatite, zirconia, or combinations thereof.

In some embodiments, the coupling agents can also be distributed within the polymerizable resin of the coating solution and can each bind to one or more filler particles, and can bind to the polymerizable resin (or cured polymerizable resin). For example, each coupling agent can have a first chemical moiety that is configured to bind to the one or more filler particles, and a second chemical moiety (different from the first chemical moiety) that is configured to bind to the polymerizable resin (or cured polymerizable resin). In some cases, the first and second chemical moieties can be situated on opposing ends of a coupling agent. Regardless of the configuration, the coupling agents being coupled to one or more filler particles can provide greater mechanical integrity for the outer layer 104 (e.g., due to the coupling between the filler particles and the polymerizable resin), and can better disperse and distribute the filler particles within the polymerizable resin. The coupling agent can be formed from various materials. For example, the coupling agent can include silane (e.g., can be a silane coupling agent), and thus the coupling agent can include 3-methacryloxypropyltrimethoxysilane, 3-acryloxypropyltrimethoxysilane, 3-glycidoxypropyltrimethoxysilane, 3-mercaptopropyltrimethoxysilane, or mixtures thereof.

In some embodiments, the photoinitiator can be a phosphine oxide or a 1,2-diketone. Some non-limiting examples of phosphine oxide photosensitizers can include 2,4-6-trimethylbenzoyl-diphenylphosphine oxide, 2,4-6-trimethylbenzoyl-diphenylphosphinate, and bis(2,4-6-trimethylbenzoyl)-phenylphosphineoxide. Some non-limiting examples of 1,2-diketones can be camphorquinone, 2,3-butanedione, 2,3-pentanedione, 2,3-hexanedione, 3,4-hexanedione, 2,3-heptanedione, 3,4-heptanedione, 2,3-octanedione, 1,2-naphthoquinone, and acenaphthaquinone.

In some embodiments, the body 102 of the dental prosthesis 100 can have a bulk material property (e.g., hardness) with a value that is substantially different than the value of the bulk material property (e.g., hardness) of the outer layer 104. For example, the surface hardness of the outer layer 104 can be greater than the surface hardness of the body 102 (e.g., when the body 102 does not include the outer layer 104), which can be higher than typical 3D printed parts. In some embodiments, the outer layer 104 of the dental prosthesis 100 can be greater than 12 Vickers Hardness Number (“VHN”), greater than 20 VHN, greater than 30 VHN, etc. In some cases, this surface hardness can be in a range between about 12 VHN to about 50 VHN, in a range between about 20 VHN to about 40 VHN, in a range between about 25 VHN to 35 VHN, etc. In some cases, this hardness can be about 38 VHN. In some configurations, the Vickers Hardness Test can yield the VHN of a material, which can typically involve driving an indenter (e.g., a diamond indenter) to create an indentation in the material. The size of the indentation and the load applied to create the indentation.

In some embodiments, the outer layer 104 can be formed out of multiple sublayers (e.g., two, three, four, etc.), with each sublayer situated on top of each other (or the body 102). For example, the outer layer 104 can include two sublayers, with a first sublayer being situated on the body 102, and a second sublayer being situated on the first sublayer. In some cases, the first sublayer can partially (or entirely) cover the outer surface of the body 102. Similarly, the second sublayer can partially (or entirely) cover the first sublayer. In some embodiments, each sublayer of the outer layer 104 can be formed out of materials previously described with regard to the outer layer 104. For example, each sublayer can be include filler particles, coupling agents, etc. In some embodiments, the material compositions of each sublayer can be different (or the same). For example, with each sublayer having a different material composition, the material properties of the dental prosthesis 100 can be specifically tailored based on, for example, the type of dental prosthesis (e.g., a crown).

In some embodiments, the dental prosthesis and the components thereof can be biocompatible (e.g., the body 102 of the dental prosthesis, the outer layer 104 of the dental prosthesis, etc.). For example, the polymerizable resin that can form the body 102 (e.g., the monomer(s), the oligomer(s), etc., of the polymerizable resin), the cured polymerizable resin that can define the body 102, etc., can be biocompatible. As another example, the coating solution that can form the outer layer 104, the cured coating solution that can define the outer layer 104, can be biocompatible. In particular, the polymerizable resin of the coating solution (e.g., the monomer(s), the oligomer(s), etc., of the polymerizable resin), the filler particles of the coating solution, the coupling agents, an initiator (e.g., a photoinitiator) of the coating solution, a solvent used to prepare the coating solution, etc., can be biocompatible.

FIG. 2 shows a schematic illustration of a cross-section of a dental crown 110, which can be a specific implementation of the dental prosthesis 100. Thus, the description regarding the dental prosthesis 100 also pertains to the dental crown 110. For example, the dental crown 110 can include a body 112, an outer layer 114, and a recess 116. As shown in FIG. 2, the outer layer 114 is coupled to and positioned entirely over an outer surface of the body 112. However, in alternative configurations, the outer layer 114 can be positioned over only a portion of the outer surface of the body 112. The recess 116 is directed through a lower side of the body 102 and defines a tooth engagement surface 118, which is abutted against a crown preparation to restore the functionality, aesthetics, etc., of the tooth. As shown in FIG. 2, the outer layer 114 does not extend into the recess 116.

FIG. 3 shows a schematic illustration of a cross-section of the dental crown 110 coupled to a crown preparation 120 of a tooth to be restored. As shown in FIG. 3, the tooth engagement surface 118 can be engaged with an inner surface of the crown preparation 120 to couple (e.g., with an adhesive, including dental cement) the dental crown 110 to the crown preparation 120. In some embodiments, while not illustrated in FIG. 2, the outer layer 114 can partially (or entirely) span the inner surface of the body 112 at the recess 116 (or in other words the intaglio surface of the body 112). Thus, in some cases, the outer layer 114 can entirely (or partially) encapsulate the body 112.

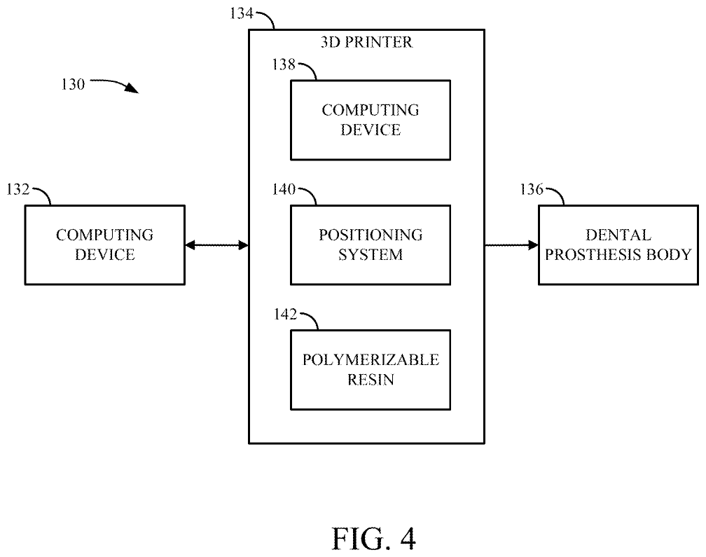

FIG. 4 shows a schematic illustration of a 3D printing system 130, which can be used to create a dental prosthesis body 136 (e.g., the body 102 of the dental prosthesis 100 or others). The 3D printing system 130 can include a computing device 132, and a 3D printer 134 in communication with the computing device 132. The computing device 132 can be implemented in different ways. For example, the computing device 132 can include typical components used such as a processor, memory, a display, inputs (e.g., a keyboard, a mouse, a graphical user interface, a touch-screen display, etc.), communication devices, etc. In some cases, the computing device 132 can simply be implemented as a processor. In some specific cases, the computing device 132 can be a laptop computer, a desktop computer, a tablet, a smartphone, a stand-alone computer system, a server, etc. The computing device 132 can transmit data to (e.g., instructions) and receive data from the 3D printer 134. For example, the computing device 132 can cause the 3D printer 134 to create the dental prosthesis body 136 (or other dental prostheses). As another example, the computing device 132 can receive imaging data (e.g., from a mouth of a patient, including for example, a cone beam computed tomography imaging data, an intraoral scan, etc.), can create a 3D volume of the dental prosthesis body 136 from the imaging data, and can transmit the 3D volume of the dental prosthesis body 136 to the 3D printer 134. In addition, the computing device 132 can communicate with other computing devices and systems, and can implement some or all of the processes described below, as appropriate.

In some embodiments, the 3D printer 134 can include a computing device 138, a positioning system 140, and a polymerizable resin 142. The computing device 138 can implement the functionalities needed to successfully create the dental prosthesis body 136 (or others) from a 3D model of the dental prosthesis body 136. For example, the computing device 138 can control the positioning system 140, which includes an extruder, according to various settings of the 3D printer 134 and according to the 3D model of the dental prosthesis body 136. In some configurations, the computing device 138 of the 3D printer 134 can periodically deposit polymerizable resin into a layer according to the 3D model of the dental prosthesis body 136, and after depositing the layer, can active a light of the 3D printer 134 to cure the layer of polymerizable resin (e.g., via a photoinitiator within the polymerizable resin). This process can repeat until the entire dental prosthesis body 136 has been created.

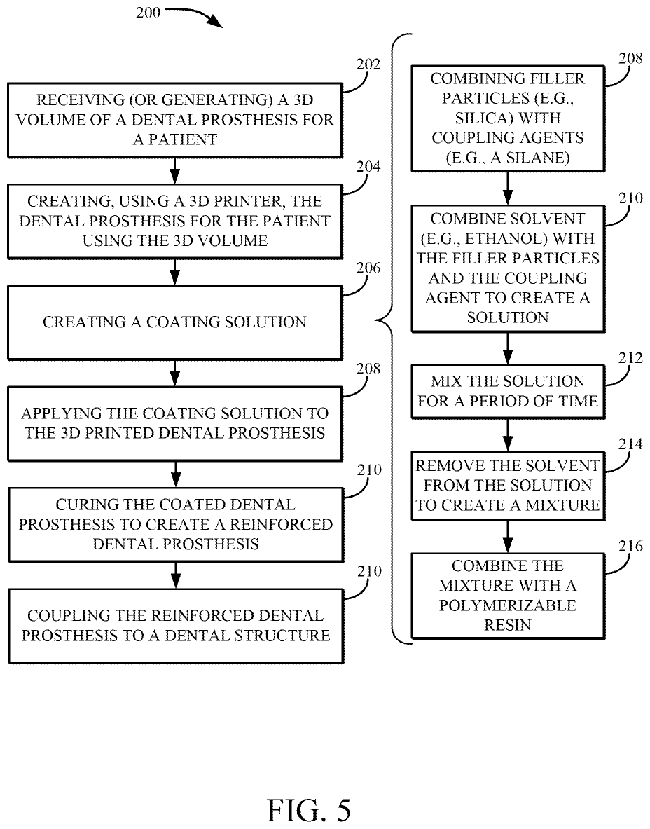

FIG. 5 shows a flowchart of a process 200 for creating a reinforced dental prosthesis (e.g., the body 102 having the outer layer 104 coupled thereto). In some embodiments, some or all of the blocks of the process 200 can be implemented using one or more computing devices (e.g., the computing device 132), as appropriate.

At 202, the process 200 can include a computing device receiving (or generating) a 3D volume of a dental prosthesis (or a component thereof) for a patient. In some cases, a computing device (e.g., of a 3D printer) can receive a computer aided design (“CAD”) model, a stereolithography (“STL”) computer-aided design (“CAD”) model, etc., from another computing device, from retrieval from memory, etc. In other cases, a computing device can generate a 3D volume of a dental prosthesis for the patient. In this case, for example, a computing device can receive imaging data from a patient (e.g., CT imaging data, imaging data from an intraoral dental scanner), and can generate the 3D volume of the dental prosthesis based on the imaging data. In some configurations, the 3D volume of the dental prosthesis can be a modified 3D volume of the dental prosthesis. For example, a user (e.g., a dental practitioner) can modify the 3D volume such as to manually address and fix detects during the creation of the initial 3D volume. In some cases, this can include smoothing edges of the 3D volume.

At 204, the process 200 can include a computing device creating, using a 3D printer and the 3D volume of the dental prosthesis (e.g., which can be a modified 3D volume of the dental prosthesis), a 3D printed dental prosthesis (or a portion thereof, including for example, one or more faux teeth for a denture) for the patient. In some cases, this can include creating the dental prosthesis using a polymerizable resin. For example, as described above, the dental prosthesis can be created by a computing device causing the 3D printer to deposit a plurality of polymerizable resin layers, with each polymerizable resin layer cured by a computing device (e.g., activating an ultraviolet light, including a ultraviolet light source) before depositing a subsequent polymerizable resin layer on top of the cured polymerizable resin layer. In some embodiments, the process 200 can include, after the computing device has created the dental prosthesis (or a portion thereof, such as when the dental prosthesis is a denture), removing the 3D printed dental prosthesis (or a component thereof) from the 3D printer (e.g., the printing table of the 3D printer).

At 206, the process 200 can include creating a coating solution, which can be similar to the coating solution described above. In some embodiments, creating the coating solution at the block 206 can include at the block 208, combining filler particles with coupling agents to create a first mixture. In some cases, the weight per volume of the filler particles to the coupling agents can be about 50%, about 60%, about 70%, about 80%. In some cases, the weight per volume of the filler particles to the coupling agents can be about (or exactly) 70%.

In some embodiments, the process 200 can include binding each coupling agent to one or more filler particles. In some embodiments, creating the coating solution at the block 206 can include at the block 210 diluting the first mixture with a solvent to create a solution. In particular, the block 210 can include combining alcohol (e.g., ethanol), which can be the solvent, with the first mixture, which includes the filler particles and the coupling agents to create a solution.

In some embodiments, creating the coating solution at the block 206 can include at the block 212 mixing (e.g., stirring, agitating, etc.) the solution for a period of time to generate a second mixture. For example, mixing can include placing the solution in a container (e.g., a beaker) and stirring the solution for the period of time. In some cases, mixing can include utilizing a magnetic stir bar to mix the solution for the period of time. In some embodiments, the period of time can be about 1 hour, about 2 hours, about 3 hours, about 4 hours, about 5 hours, about 6 hours, about 7 hours, about 8 hours, etc.

In some embodiments, creating the coating solution at the block 206 can include at the block 214, removing at least a portion of the solvent (e.g., alcohol, including ethanol, etc.) from the solution to create the second mixture. In some cases, this can include mixing the solution until at least a portion (or all) of the solvent is removed from the solution (e.g., by evaporation) to create the second mixture.

In some embodiments, creating the coating solution at the block 206 can include at the block 216 combining the mixture (e.g., the second mixture) with a polymerizable resin to create the coating solution. In some cases, the ratio of the parts of the (second) mixture to the parts of the polymerizable resin in the coating solution can be about 1:5, about 1:6, about 1:7, about 1:8, about 1:9, about 1:10, about 1:11, about 1:12, etc. In some embodiments, the polymerizable resin can have one or more polymerizable monomers, one or more polymerizable oligomers, or combinations thereof. For example, the polymerizable resin can include both polymerizable monomers, and polymerizable oligomers, with the amount of polymerizable monomers of the polymerizable resin being greater than 60 percent by weight, and with the amount of polymerizable oligomers of the polymerizable resin being between about 15 percent by weight to about 25 percent by weight. In some embodiments, the polymerizable resin can include a polymerizing initiator. For example, the polymerizing initiator can be a photoinitiator (e.g., one sensitive to ultraviolet light). In this case, the amount of photoinitiator of the polymerizable resin can be less than two percent by weight. In some embodiments, the polymerizable resin is a resin that is a 3D printer capable resin. For example, the polymerizable resin can be a commercially available 3D printer resin (e.g., NextDent™ C&B MFH, available from NextDent®, Soesterberg, Netherlands). In some cases, the polymerizable resin used to create the 3D printed dental prosthesis at the block 204 can be the same or substantially the same as the polymerizable resin of the coating solution. For example, one or more components (e.g., the type of monomer, the type of oligomer, the concentration of monomer, the concentration of oligomer, etc.) of the polymerizable resin used to create the 3D printed dental prosthesis at the block 204 can be the same as one or more components of the polymerizable resin of the coating solution.

In some embodiments, the block 216 can include shielding the coating solution (and the polymerizable resin) from light that interacts with a photosensitizer of the coating solution or the polymerizable resin. For example, if the photosensitizer responds to ultraviolet light, then at the block 216, the method can include shielding the coating solution (e.g., while the coating solution is mixed).

At 208, the process 200 can include applying the coating solution to the 3D printed dental prosthesis to create a coated 3D printed dental prosthesis. In some cases, this can include submersing the 3D printed dental prosthesis in the coating solution, while in other cases this can include pouring the coating solution over the 3D printed dental prosthesis. In some cases, the 3D printed dental prosthesis can be placed on a mesh that has holes directed therethrough. In this way, when the coating solution is applied to the 3D printed dental prosthesis, excess coating solution flows off the 3D printed dental prosthesis (e.g., through the holes and into a reservoir), which can ensure a uniform coating of the coating solution on the 3D printed dental prosthesis.

At 210, the process 200 can include curing the coated 3D printed dental prosthesis to create a reinforced dental prosthesis. In some cases, this can include applying heat to the coated dental prosthesis, emitting light (e.g., ultraviolet (“UV”) light) onto the coated dental prosthesis (e.g., if the polymerizable resin includes a photoinitiator that responds to UV light), etc. In some embodiments, the process 200 can proceed back to the block 208, if for example, multiple cured layers are desired (e.g., multiple sublayers of an outer surface). In this case, the reinforced dental prosthesis can include multiple (e.g., two, three, four, etc.) cured coating solution layers (e.g., sublayers), with a first layer positioned on the 3D printed dental prosthesis, with a second layer positioned on the previous layer, and so on. In this case, the reinforced dental prosthesis (e.g., with one cured coating layer) can be subjected to an additional application of the coating solution followed by curing of this coating solution, which can be implemented a desired number of times (e.g., one, two, three, etc.). In this way, the thickness of the outer layer of the dental prosthesis can be increased in size until the outer layer reaches the desired thickness. In some cases, thicker outer layers can be yield stronger and harder dental prostheses. In some configurations, each sublayer can include different material compositions (e.g., different filler particle percentages, different types of filler particles, etc.). In this way, the mechanical properties of a dental prosthesis can be specifically tailored for the specific type of dental prosthesis.

At 212, the process 200 can include coupling the reinforced dental prosthesis to a dental structure. For example, when the reinforced dental prosthesis is a faux tooth, the dental structure can be a base for a denture (or partial denture). In this way, the faux tooth can be coupled to the base of the denture. In some cases, the process 200 can be repeated for each dental prosthesis (e.g., each faux tooth) for a denture (or partial denture). As another example, when the reinforced dental prosthesis is a crown, the dental structure can be a crown preparation. Thus, the reinforced dental prosthesis can be coupled to the crown preparation (e.g., using dental adhesive) by, for example, inserting the crown preparation into a recess of the crown.

### EXAMPLES

The following examples have been presented in order to further illustrate aspects of the disclosure, and are not meant to limit the scope of the disclosure in any way. The examples below are intended to be examples of the present disclosure and these (and other aspects of the disclosure) are not to be bounded by theory.

Some embodiments of the disclosure provide a surface treatment technology using 3D printing post-process by addition of a surface-finishing layer with resin incorporated with various composite particles to enhance surface properties.

Some 3D printed (“3DP”) resins provide consistent bulk material properties. However, one shortcoming would be the surface property of the printed product depends solely on the properties of the printing resins. In other words, softer bulk material will form a softer surface property. If, however, one needs to print softer bulk with harder wear resistant surfaces, it becomes a very difficult task. In order to enhance surface properties from the bulk property, printing technology needs to be much more sophisticated to be capable of dispensing multiple resins in multiple layers to achieve different mechanical properties.

A new innovative concept and technology is disclosed herein that can modify surface material properties of 3D printed objects implemented in its post-printing process, therefore being able to achieve altered surface mechanical properties different than its bulk material. This concept can be applied to create a 3DP object composed of resin favorable for strong but not too rigid bulk property with the surface much harder with superior wear resistance by applying a coat during the post-printing process. The coat can include resin added with silanized-silica and/or silica particles and/or any other surface properties additives. This particular disclosure aims to develop a 3DP dental prosthesis material.

In general, the surface hardness is an important consideration for dental materials because restored teeth surfaces constantly react to the daily cyclical use, requiring these surfaces to resist against wear and fatigue. At the same time, fatigue created from occlusion requires materials capable of damping the stress to dissipate energy exerted onto the teeth and other supporting bone and soft tissue structures. This application can, for example, be used in the full denture fabrication process. A provider can fabricate a full denture with softer, compliant material and then enhance the mechanical properties of dentures by adding the final surface layer with long-fiber strengthened resin composite.

This disclosure is aimed to create a 3D printed indirect dental prosthesis material suitable to withstand cyclic occlusal load with strong yet compliant bulk property while being able to resist wear and cracking on the outer surfaces with hard, wear-resisting surface properties using a simple in-office 3D printing system. This novel concept can include printing an object with 3D printing resin, and applying a surface layer having a different property than the bulk property of the 3D printed object. In some cases, different sized and shaped composite particles can be added to uncured resin, which can be applied to the surface of the 3D printed object. Then, the surface layer can be cured during the post-printing process. This is a significant innovation because composite particle additions such as fiber forms, or larger size and other materials may not be suitable for use during 3D printing at least because 3D printing materials (e.g., resins) that are heterogeneous (e.g., having filler particles) may not be compatible to the 3D printing mechanism. The systems and methods disclosed herein, however, can utilize simple in-office 3D printing and integrate these type of composite additives on the surface during the post-print process. This addition during the post-processing treatment opens opportunity to improve surface properties that is fundamental to dental restorative longevity.

Following is a disclosure of specific method that was used to apply the novel concept to produce a 3D printed bi-layer product. Materials used to synthesized salinized-silica with commercially available 3DP resins, included fumed silica with the average size of 0.2-0.3 μm, gamma-methacryloxypropyl trimethoxysilane a silane used commonly in dental composites, and a 3DP-resin material comprising greater than 60 wt. % methacrylic oligomer, 15-25 wt. % glycol methacrylate (also known as (hydroxyethyl)methacrylate), and less than 2.5 wt. % phosphine oxide (NextDent™ C&B MFH commercially available from NextDent®, Soesterberg, Netherlands).

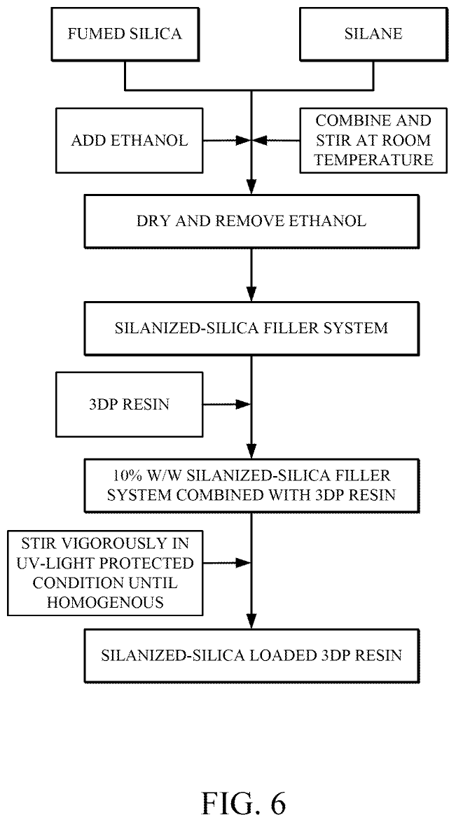

FIG. 6 shows a flowchart of a process used to create the 3DP resin. The silane was measured out to carry out a solution with fumed silica. The filler system is not limited to fumed silica and can be substituted with other systems, materials, etc. The silica weight to silane ratio was determined as generally 70% w/v silica to silane, however, this ratio can be altered and is not limited. Similarly, additives are not limited to silica and other various sized and shaped additives can be used such as titanium particles, zirconia particles, fiber forms of additives, etc. The solution was mixed with 200 mL of ethanol to dilute the solution and was mixed vigorously on a magnetic stirrer. The solution was stirred for a total of 7-hrs and all the ethanol was removed from the solution. The remaining solute was the product of 70% w/v silica-silane. The solute was mixed with the 3DP resin in a ratio of 1:10 and was stirred vigorously until homogenous in UV-light protected conditions to produce the product. The ratio can be altered and is not limited to 1:10. The product was applied to the surface of freshly printed samples after it was post-printed to remove all excess resin. The sample was surface coated with the product and followed the protocol to be post-processed cured in a UV-light chamber. The resulting sample after the post-process cured was removed and tested for surface hardness and wear resistance.

Some embodiments of the disclosure describe the effects of filler-surface on hardness and wear of 3D-printed composites. Some embodiments of the disclosure evaluate the efficacy of a novel method that applies silanized-glass filler incorporated Three-Dimensional Printed (“3DP”)-resin to sample surface during post-printing process (“PPP”) to improve surface hardness and wear resistance properties.

In some embodiments, a novel method was used to fabricate 3DP-resin material (NextDent™ C&B MFH, available from NextDent , Soesterberg, Netherlands) with PPP applying a thin layer of unpolymerized resin mixed with fumed Silica particles (average size 0.2-0.3 μm) surface-treated with γ-methacryloxypropyl trimethoxysilane (Sigma-Aldrich, St. Louis, Mo.), then UV-cured in a SprintRay post-cure chamber(SprintRay, Los Angeles, Calif.). The Control Group is 3DP-resin with normal PPP and the Experimental Group is surface treated during PPP.

Samples were evaluated for surface roughness change with a profilometer, PCE-RT1200 (PCE America, Jupiter, Fla.) after abrasion under tooth-brushing simulator. Sample thickness and weight before and after brushing simulation were also measured. Vickers surface hardness was measured. Sample size of n=8 selected, based on the recommended optimal values of pilot trial for two-tailed main trial designed with 80% upper confidence level and standardized differences of 0.9 with 80% power.

All results are presented in the table 1 below. Two tailed t-test compared the means of the two experimental groups. Surface hardness was significantly increased with novel PPP method that was developed.

TABLE 1
Results from Testing of the Reinforced and Non-Reinforced 3DP Materials

| | Vickers Hardness Number | Percent Change in Thickness | Percent Change in Mass |
|---|---|---|---|
| | (“VHN”) (±SD, n = 8) | Δ % Thickness (±SD, n = 8) | Δ % Mass (±SD, n = 8) |
| Control | 10.87 ± 0.77* | 2.70 ± 2.63 | 0.73 ± 0.25 |
| Experimental | 38.5 ± 3.4* | 0.92 ± 1.31 | 0.69 ± 0.65 |

(*p < 0.5)

In this study a novel method was applied that surface treats 3DP-compatiable resin with silane-modified silica particles (70% w/w). With this modification, increased hardness was reported for 3DP-resin when compared to the unmodified resin. As a result, 3DP-resin can increase its surface hardness by including an additional step during the PPP by applying a layer of 3DP-resin added with silanized glass fillers. This disclosure adds to the possibility of 3DP-resin as an indirect restorative material for inlays and onlays applied chairside for clinical applications, via digital intraoral scanning, computer design, and chairside fabrication via additive manufacturing in a form of 3DP technology.

The present disclosure has described one or more preferred embodiments, and it should be appreciated that many equivalents, alternatives, variations, and modifications, aside from those expressly stated, are possible and within the scope of the invention.

It is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

As used herein, unless otherwise limited or defined, discussion of particular directions is provided by example only, with regard to particular embodiments or relevant illustrations. For example, discussion of “top,” “front,” or “back” features is generally intended as a description only of the orientation of such features relative to a reference frame of a particular example or illustration. Correspondingly, for example, a “top” feature may sometimes be disposed below a “bottom” feature (and so on), in some arrangements or embodiments. Further, references to particular rotational or other movements (e.g., counterclockwise rotation) is generally intended as a description only of movement relative a reference frame of a particular example of illustration.

In some embodiments, aspects of the disclosure, including computerized implementations of methods according to the disclosure, can be implemented as a system, method, apparatus, or article of manufacture using standard programming or engineering techniques to produce software, firmware, hardware, or any combination thereof to control a processor device (e.g., a serial or parallel general purpose or specialized processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, embodiments of the disclosure can be implemented as a set of instructions, tangibly embodied on a non-transitory computer-readable media, such that a processor device can implement the instructions based upon reading the instructions from the computer-readable media. Some embodiments of the disclosure can include (or utilize) a control device such as an automation device, a special purpose or general purpose computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.).

The term “article of manufacture” as used herein is intended to encompass a computer program accessible from any computer-readable device, carrier (e.g., non-transitory signals), or media (e.g., non-transitory media). For example, computer-readable media can include but are not limited to magnetic storage devices (e.g., hard disk, floppy disk, magnetic strips, and so on), optical disks (e.g., compact disk (CD), digital versatile disk (DVD), and so on), smart cards, and flash memory devices (e.g., card, stick, and so on). Additionally it should be appreciated that a carrier wave can be employed to carry computer-readable electronic data such as those used in transmitting and receiving electronic mail or in accessing a network such as the Internet or a local area network (LAN). Those skilled in the art will recognize that many modifications may be made to these configurations without departing from the scope or spirit of the claimed subject matter.

Certain operations of methods according to the disclosure, or of systems executing those methods, may be represented schematically in the FIGS. or otherwise discussed herein. Unless otherwise specified or limited, representation in the FIGS. of particular operations in particular spatial order may not necessarily require those operations to be executed in a particular sequence corresponding to the particular spatial order. Correspondingly, certain operations represented in the FIGS., or otherwise disclosed herein, can be executed in different orders than are expressly illustrated or described, as appropriate for particular embodiments of the disclosure. Further, in some embodiments, certain operations can be executed in parallel, including by dedicated parallel processing devices, or separate computing devices configured to interoperate as part of a large system.

As used herein in the context of computer implementation, unless otherwise specified or limited, the terms “component,” “system,” “module,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

In some implementations, devices or systems disclosed herein can be utilized or installed using methods embodying aspects of the disclosure. Correspondingly, description herein of particular features, capabilities, or intended purposes of a device or system is generally intended to inherently include disclosure of a method of using such features for the intended purposes, a method of implementing such capabilities, and a method of installing disclosed (or otherwise known) components to support these purposes or capabilities. Similarly, unless otherwise indicated or limited, discussion herein of any method of manufacturing or using a particular device or system, including installing the device or system, is intended to inherently include disclosure, as embodiments of the disclosure, of the utilized features and implemented capabilities of such device or system.

As used herein, unless otherwise defined or limited, ordinal numbers are used herein for convenience of reference based generally on the order in which particular components are presented for the relevant part of the disclosure. In this regard, for example, designations such as “first,” “second,” etc., generally indicate only the order in which the relevant component is introduced for discussion and generally do not indicate or require a particular spatial arrangement, functional or structural primacy or order.

As used herein, unless otherwise defined or limited, directional terms are used for convenience of reference for discussion of particular figures or examples. For example, references to downward (or other) directions or top (or other) positions may be used to discuss aspects of a particular example or figure, but do not necessarily require similar orientation or geometry in all installations or configurations.

This discussion is presented to enable a person skilled in the art to make and use embodiments of the disclosure. Various modifications to the illustrated examples will be readily apparent to those skilled in the art, and the generic principles herein can be applied to other examples and applications without departing from the principles disclosed herein. Thus, embodiments of the disclosure are not intended to be limited to embodiments shown, but are to be accorded the widest scope consistent with the principles and features disclosed herein and the claims below. The following detailed description is to be read with reference to the figures, in which like elements in different figures have like reference numerals. The figures, which are not necessarily to scale, depict selected examples and are not intended to limit the scope of the disclosure. Skilled artisans will recognize the examples provided herein have many useful alternatives and fall within the scope of the disclosure.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” Further, a list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of each of A, B, and C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C. In general, the term “or” as used herein only indicates exclusive alternatives (e.g. “one or the other but not both”) when preceded by terms of exclusivity, such as “either,” “one of,” “only one of,” or “exactly one of.”

Also as used herein, unless otherwise specified or limited, the terms “about” and “approximately,” as used herein with respect to a reference value, refer to variations from the reference value of ±15% or less (e.g., ±10%, ±5%, etc.), inclusive of the endpoints of the range. Similarly, the term “substantially equal” (and the like) as used herein with respect to a reference value refers to variations from the reference value of less than ±30% (e.g., ±20%, ±10%, ±5%) inclusive. Where specified, “substantially” can indicate in particular a variation in one numerical direction relative to a reference value. For example, “substantially less” than a reference value (and the like) indicates a value that is reduced from the reference value by 30% or more, and “substantially more” than a reference value (and the like) indicates a value that is increased from the reference value by 30% or more.

Various features and advantages of the disclosure are set forth in the following claims.

What is claimed is:

1. A dental prosthesis comprising:
a body being formed by three-dimensional printing, the body defining an outer surface; and
an outer layer coupled to the body and covering at least a portion of the outer surface of the body, the outer layer comprising a cured polymerizable resin and filler particles distributed within the cured polymerizable resin.

2. The dental prosthesis of claim 1, wherein the body of the dental prosthesis is biocompatible; and
wherein the outer layer of the dental prosthesis is biocompatible.

3. The dental prosthesis of claim 1, wherein the dental prosthesis is at least one of a crown, an inlay, an onlay, a bridge, a veneer, or a faux tooth of a partial or full denture.

4. The dental prosthesis of claim 1, wherein the body is formed from a first cured polymerizable resin, the first cured polymerizable resin not including filler particles;
wherein the cured polymerizable resin of the outer layer is a second cured polymerizable resin; and
wherein a first polymerizable resin that forms the first cured polymerizable resin of the body includes at least some of the same components as a second polymerizable resin that forms the second cured polymerizable resin of the outer layer.

5. The dental prosthesis of claim 4, wherein the at least some of the same components include the same type of monomer, or the same type of oligomer.

6. The dental prosthesis of claim 4, wherein the first polymerizable resin is the same as the second polymerizable resin.

7. The dental prosthesis of claim 1, wherein a cross-sectional thickness of the outer layer is smaller than a cross-sectional thickness of the body; and
wherein the cross-sectional thickness of the outer layer is in a range between about 20 micrometers and about 90 micrometers.

8. The dental prosthesis of claim 7, wherein the outer layer includes a plurality of sublayers; and
wherein each of the plurality of sublayers has been cured independently of any of the other sublayers.

9. The dental prosthesis of claim 1, wherein the outer layer includes one or more coupling agents that binds to one or more of the filler particles and the cured polymerizable resin.

10. The dental prosthesis of claim 9, wherein the filler particles each have a width that is within a range of about 0.2 μm to about 0.3μm;
wherein the filler particles include silica;
wherein the coupling agents include a silane; and
wherein a polymerizable resin used to form the cured polymerizable resin of the outer layer includes a photoinitiator that facilitates curing of the polymerizable resin.

11. The dental prosthesis of claim 1, wherein the outer layer of the dental prosthesis has a hardness greater than 30 Vickers Hardness Number (VHN).

12. A denture comprising:
a body and a faux tooth coupled to the body that defines an outer surface;
an outer layer coupled to and covering at least a portion of the outer surface of the faux tooth, the outer layer comprising a cured polymerizable resin and filler particles distributed within the cured polymerizable resin; and
wherein at least one of the body or the faux tooth is formed by three-dimensional printing.

13. The denture of claim 12, wherein the denture includes a plurality of faux teeth that includes the faux tooth;
wherein each of the plurality of faux teeth includes a respective outer surface that is at least partially covered by a respective outer layer that includes the cured polymerizable resin and the filler particles distributed within the cured polymerizable resin.

14. The denture of claim 12, wherein the outer layer of the faux tooth has a hardness greater than 30 Vickers Hardness Number (VHN).

15. The denture of claim 12, wherein the faux tooth is formed from a first cured polymerizable resin, the first cured polymerizable resin not including filler particles;
wherein the cured polymerizable resin of the outer layer is a second cured polymerizable resin; and
wherein a first polymerizable resin that forms the first cured polymerizable resin of the faux tooth includes at least some of the same components as a second polymerizable resin that forms the second cured polymerizable resin of the outer layer.

16. A method of creating a reinforced dental prosthesis, the method comprising:
(a) providing a three-dimensional (3D) printed dental prosthesis;
(b) applying a coating solution to at least a portion of an outer surface of the 3D printed dental prosthesis, the coating solution comprising a polymerizable resin and filler particles distributed within the polymerizable resin; and
(c) curing the coating solution on the 3D printed dental prosthesis to create the reinforced dental prosthesis.

17. The method of claim 16, wherein the coating solution includes a photoinitiator, and step (c) comprises directing light at the coating solution to cure the coating solution.

18. The method of claim 16, wherein the 3D printed dental prosthesis has been formed from a first polymerizable resin;
wherein the polymerizable resin is a second polymerizable resin;
wherein the first polymerizable resin is the same as the second polymerizable resin.

19. The method of claim 16, wherein the 3D printed dental prosthesis has been formed from a first polymerizable resin that does not include filler particles; and
wherein the polymerizable resin is a second polymerizable resin.

20. The method of claim 16, wherein the coating solution includes a coupling agent that binds to one or more of the filler particles.
